(19) United States
(12) Patent Application Publication
(10) Pub. No.: US 2006/0111524 A1
(43) Pub. Date: May 25, 2006

(54) High-activity magnesium-supported catalyst and method of preparing polyolefin using the same

(76) Inventors: Yiyoung Choi, Daejeon-city (KR); Churlyoung Park, Daejeon-city (KR); Hyuckju Kwon, Yeosu-city (KR); Donghwan Ahn, Yeosu-city (KR); Soonyeel Lee, Daejeon-city (KR)

Correspondence Address: CANTOR COLBURN, LLP, 55 GRIFFIN ROAD SOUTH, BLOOMFIELD, CT, 06002, US

(21) Appl. No.: 11/266,464

(22) Filed: Nov. 3, 2005

(30) Foreign Application Priority Data
Nov. 3, 2004 (KR) 10-2004-0088917

(51) Int. Cl. C08F 4/44; B01J 31/00

(52) U.S. Cl. 526/124.3; 526/901; 502/103; 502/118; 502/128

(57) ABSTRACT

A high-activity catalyst used to prepare polyethylene and a method of preparing polyolefin using the same are provided. When preparing the high-activity catalyst, a specific halogenated hydrocarbon is added to control the electrical properties of catalytic active sites and provide a large steric space around the catalytic active sites. Therefore, polyolefin with a wide range of molecular weights can be synthesized using the catalyst.

### CROSS-REFERENCE TO RELATED PATENT APPLICATIONS

This application claims the benefit of Korean Patent Application No. 10-2004-0088917, filed on Nov. 3, 2004, in the Korean Intellectual Property Office, the disclosure of which is incorporated herein in its entirety by reference.

### BACKGROUND OF THE INVENTION

1. Field of the Invention

The present invention relates to a high-activity magnesium-supported catalyst which can be used to prepare polyolefin with a wide range of molecular weights, a method of preparing the catalyst, and a method of preparing polyolefin using the catalyst.

2. Description of the Related Art

Ziegler-Natta catalysts consisting of a transition metal main catalyst and a organic metal cocatalyst, which were invented by Ziegler and Natta in the 1950s, have been widely used in a polyolefin preparation process. However, the catalyst is uneconomical due to its low catalytic activity. Further, the residue of the catalyst causes problems in the physical properties, flavor, taste, color, etc. of polymers. Accordingly, a process of removing catalytic residues and a method of using a carrier to improve the catalytic activity have been suggested to improve the catalyst. Silica, magnesium compounds, etc., are used as carriers. In particular, MgCl₂ is most suitable to carry a titanium compound and has high polymerization activity.

However, the cost of catalysts still accounts for a large fraction of the manufacturing cost of polyolefin. In addition, the catalytic residue remaining in polyolefin deteriorates the physical properties of polyolefin.

In particular, polyolefin products used for food packing materials or containers cause an off-flavor or off-taste due to catalytic residues, are toxic to the human body, and thus have limited applications. Therefore, to improve the physical properties of polymer and solve the problems arising with catalytic residues, it is very important to use a high-activity catalyst.

Polyolefin with a wide range of molecular weights has good processibility. Bottle products, which are hollow, can be manufactured from such a material with a wide molecular weight distribution. Conventionally, to widen the range of molecular weights, two reactors are connected in series and controlled to be supplied with different amounts of hydrogen in the reactors. However, the operating costs are high, and investment in equipment is necessary.

According to the disclosure of U.S. Pat. No. 4,302,566, to increase the polymerization activity of a catalyst, a conventional silica carrier is treated with an organic aluminum compound, dehydrated, and surface-treated using trichloroethanol to increase the pore size of the silica carrier to improve the reactivity with ethylene. However, this method markedly increases the reactivities of hydrogen and comonomers, but does not sufficiently increase the polymerization activity.

As another example, European Patent No. 5,124,296 discloses a method of preparing a catalyst using alkyl magnesium as a magnesium compound carrier. However, this method is costly.

Korean Patent No. 10444816 discloses a method of preparing polyolefin using an olefin polymerization catalyst consisting of a solid titanium catalyst component, an organic aluminum catalyst component, and an organic silicon compound catalyst component with Si—O—C bonds. The solid titanium catalyst component containing titanium, magnesium, and halogen as essential components is prepared by contacting a magnesium compound and a titanium compound solution containing 88-99% by weight of a titanium compound and 1-12% by weight of hydrocarbon containing halogenated hydrocarbon. This method discloses the use of a catalyst with high polymerization activity but fails to provide polyolefin with a wide molecular weight distribution.

Chinese Patent No. 1,071,934 discloses a method of preparing a catalyst in which a mixture of a magnesium compound and a zinc compound is used to form a carrier. The catalyst has a high olefin polymerization activity, and the molecular weight distribution of polyolefin can be varied according to the mixing ratio of the carrier components. However, this method is complicated.

### SUMMARY OF THE INVENTION

The present invention provides a method of preparing a catalyst which can be used to prepare polyolefin with a wide range of molecular weights. The catalyst is prepared by adjusting the electrical properties of catalytic active sites to provide a sufficiently large steric space between the catalytic active sites and has very high polymerization activity.

The present invention provides a method of preparing polyolefin using the above-described catalyst.

According to an aspect of the preset invention, there is provided a method of preparing a catalyst for olefin polymerization, the method comprising: (a) contacting a solid anhydrous magnesium carrier and an alcohol of formula (1) below in a non-polar solvent to react the solid anhydrous magnesium carrier and the alcohol; (b) contacting the reaction product from (a) and at least one titanium compound of formula (2) below to react the product from (a) and the titanium compound; and (c) adding a halogenated hydrocarbon of formula (3) below during (a) or after (b) for reaction with the reactants:
R¹—OH (1)

where R¹ is an alkyl group having 6-10 carbon atoms.
Ti(OR²)lX₄₋ₗ (2)

where each R² is the same or different and is an alkyl group having 1-10 carbon atoms, X is a halogen atom, and l is an integer from 0 to 4.
R³X (3)

where R³ is a substituted or unsubstituted aryl group having 6-30 carbon atoms, a substituted or unsubstituted heteroaryl group having 4-30 carbon atoms, a substituted or unsubstituted cycloalkyl group having 5-30 carbon atoms, or a substituted or unsubstituted heterocycloalkyl group having 3-30 carbon atoms; and X is a halogen atom.

The method may further comprise contacting the reaction product from (a) and at least one alcohol of formula (4) below after the reaction in (a):
R⁴—OH (4)

where R⁴ is an alkyl group having 1-5 carbon atoms.

The method may further comprise sufficiently washing the reaction product from (b) with a non-polar solvent before (c) when the halogenated hydrocarbon of formula (3) is added after the reaction between the reaction product from (a) and the titanium compound of formula (2) in (b).

The amount of the alcohol of formula (1) in molar ratio may be in a range of 1-10:1 with respect to the amount of the solid anhydrous magnesium carrier.

The amount of the alcohol of formula (4) in molar ratio may be in a range of 0.25-10:1 with respect to the amount of the solid anhydrous magnesium carrier.

The amount of the halogenated hydrocarbon of formula (3) in molar ratio may be in a range of 0.1-500:1 with respect to the total amount of the alcohol.

The amount of the titanium compound of formula (2) in molar ratio may be in a range of 1-20:1 with respect to the amount of the solid anhydrous magnesium carrier.

The molar ratio of the halogenated hydrocarbon of formula (3) to the titanium compound of formula (2) may be in a range of 0.1-500:1.

The reaction temperature in (a) may be in a range of 20-150° C.

The reaction temperature in (b) may be in a range of −20-80° C.

The reaction temperature in (c) may be in a range of 20-120° C.

According to another aspect of the present invention, there is provided a catalyst prepared using the above-described method.

According to another aspect of the present invention, there is provided a method of preparing polyolefin using the catalyst and a cocatalyst of formula (5) below:
(R⁵)yMX′ (_{3-y}) (5)

where each R⁵ is the same or different and is an alkyl group having 1-10 carbon atoms; M is an element selected from the group consisting of group IB elements, group IIA elements, group IIIB elements, and group IVB elements in the Periodic Table of Elements; X′ is a halogen; and y is an integer from 1 to 3.

The polymerization method of preparing polyolefin may be performed in a slurry or vapor-phase process.

The polymerization method of preparing polyolefin may be performed at a temperature of 50-150° C.

The high-activity magnesium-supported titanium catalyst according to the present invention can be used together with an organic metallic cocatalyst in a vapor-phase or slurry process to polymerize ethylene or copolymerize ethylene with α-olefin. In this manner, the high-activity magnesium-supported titanium catalyst according to the present invention can be used to manufacture common molded products, films, food containers, hollow molded products, etc.

### DETAILED DESCRIPTION OF THE INVENTION

Hereinafter, the present invention will be described in detail.

Polyethylene prepared with a Ziegler-Natta catalyst has excellent physical properties and excellent processibility due to its wide range of molecular weights. Accordingly, the polyethylene has various applications and can be used in most plastic products available worldwide.

The present invention provides a high-activity magnesium-supported Ziegler-Natta catalyst which can be produced at low costs and reduces a residue remaining in polyethylene synthesized using the same and a method of preparing polyethylene with a wide range of molecular weights using the catalyst.

According to the present invention, when preparing the catalyst, a magnesium compound is used as a carrier, and the properties of alcohol, halogenated hydrocarbon, and a titanium compound are controlled, thereby resulting in the catalyst with high activity.

A method of preparing a catalyst for polymerizing olefin according to the present invention includes: (a) contacting a solid anhydrous magnesium carrier and an alcohol of formula (1) below in a non-polar solvent to react the solid anhydrous magnesium carrier and the alcohol; (b) contacting the resulting product and at least one titanium compound of formula (2) below to react the product from (a) and the titanium compound; and (c) adding a halogenated hydrocarbon of formula (3) during (a) or after (b) for reaction with the reactants.
R¹—OH (1)

where R¹ is an alkyl group having 6-10 carbon atoms.
Ti(OR²)lX₄₋ₗ (2)

where each R² is the same or different and is an alkyl group having 1-10 carbon atoms, X is a halogen atom, and l is an integer from 0 to 4.
R³X (3)

where R³ is a substituted or unsubstituted aryl group having 6-30 carbon atoms, a substituted or unsubstituted heteroaryl group having 4-30 carbon atoms, a substituted or unsubstituted cycloalkyl group having 5-30 carbon atoms, or a substituted or unsubstituted heterocycloalkyl group having 3-30 carbon atoms; and X is a halogen atom.

Examples of the solid anhydrous magnesium carrier include magnesium oxide, magnesium chloride, silica-magnesia, magnesia, and a mixture thereof, wherein magnesium chloride is most preferred.

The solid anhydrous magnesium carrier has a particle size of 0.1-200 μm, for example, 10-150 μm. The carrier has a micro-spherical particle shape. The carrier may be anhydrous magnesium chloride having a water content of less than 1.0%.

In formula (1) above, R¹ is an alkyl group having 6-10 carbon atoms. Examples of alcohol in formula (1) include n-hexanol, 1-octanol, 2-ethyl-1-hexanol, etc., wherein 2-ethyl-1-hexanol is most preferred.

The amount of the alcohol of formula (1) in molar ratio may be in a range of 1-10:1, preferably, 1.5-8:1, more preferably, 2-6:1, with respect to the anhydrous magnesium carrier.

A method commonly used to react the solid anhydrous magnesium carrier and the alcohol of formula (1) includes: adding the alcohol to a slurry of the non-polar solvent and the solid anhydrous magnesium carrier or directly adding a solution of the alcohol dissolved in the non-polar solvent to the solid anhydrous magnesium carrier to obtain a slurry; and reacting the slurry at a temperature of about 20-150° C. for a sufficient duration of time until a transparent solution is obtained.

After the solution is cooled down to room temperature, at least one alcohol of formula (4) below may be further added and reacted.
R⁴—OH (4)

where R⁴ is an alkyl group having 1-5 carbon atoms.

Examples of the alcohol of formula (4) include methanol, ethanol, 1-propanol, isopropanol, n-butanol, isobutanol, 1-pentanol, isopentanol, etc., wherein methanol and ethanol are most preferred.

The amount of the alcohol of formula (4) in molar ratio may be in a range of 0.25-10:1, and preferably, 0.4-6:1, with respect to the anhydrous magnesium carrier.

When adding the alcohol of formula (4), at least one of the alcohol of formula (4) or a mixture of the alcohol of formula (4) and a non-polar solvent is dropwise added to the reaction mixture of the anhydrous magnesium carrier and the alcohol of formula (1). The resulting reaction product is reacted at room temperature or about 20-120° C. for a sufficient duration of time, for example, overnight, while stirring to allow complete reaction of alcohol.

Next, the reaction product of the anhydrous magnesium carrier and the alcohol is brought to contact at least one titanium compound of formula (2).

In formula (2) above, R² is an alkyl group of 1-10 carbon atoms, preferably, 2-8 carbon atoms, and more preferably, 3-5 carbon atoms; X may be Br or Cl, wherein Cl is preferred; and l is an integer from 0 to 4. The titanium compound of formula (2) may be titanium tetrachloride or titanium oxide chloride.

The titanium compound may be directly added to the slurry of the carrier. Alternatively, the titanium compound may be added to the slurry of the carrier after being dissolved in a suitable solvent, such as a non-polar solvent. In other words, the titanium compound of formula (2) is added to the reaction mixture of the alcohol and the anhydrous magnesium carrier directly or after being dissolved in a non-polar solvent and reacted at a temperature of −20-120° C., for example, 20-80° C., in a reactor at a stirring rate of 10-500 rpm, for example, 50-400 rpm, for a sufficient duration of time.

The amount of the used titanium compound of formula (2) in molar ratio may be 20:1, for example, 10:1, with respect to the anhydrous magnesium carrier.

When adding at least two titanium compounds, the titanium compounds may be sequentially or simultaneously added. When at least two titanium compounds are sequentially added, the second titanium compound is dropwise added at a temperature of −20-120° C., for example, 20-80° C., and stirred for a sufficient duration of time.

The halogenated hydrocarbon of formula (3) may be added while the alcohol solution is reacted with the anhydrous magnesium carrier in (a) or after the titanium compound is added and reacted in (b).

In formula (3) above, R³ is a substituted or unsubstituted aryl group having 6-30 carbon atoms, a substituted or unsubstituted heteroaryl group having 4-30 carbon atoms, a substituted or unsubstituted cycloalkyl group having 5-30 carbon atoms, or a substituted or unsubstituted heterocycloalkyl group having 3-30 carbon atoms; and X is a halogen atom, such as F, Cl, or Br.

Examples of the halonegated hydrocarbon in formula (3) include, but are not limited to, chlorocyclohexane, chlorobenzene, dichlorobenzene, cyclopropylbromide, 2-chlorobenzene, chlorocyclobutane, tetrachlorobenzene, trichlorobenzene, bromocyclohexane, chlorobenzylchloride, benzylchloride, dichlorophenylcyclopropane, etc.

The amount of the halogenated hydrocarbon of formula (3) in molar ratio may be in a range of 0.1-500:1, for example, 0.2-200:1, with respect to the total amount of used alcohol.

When adding the halogenated hydrocarbon during (a) and both the alcohol of formula (1) and the alcohol of formula (2) are added, the halogenated hydrocarbon may be added simultaneously with the addition of the alcohol of formula (1). Alternatively, the halogenated hydrocarbon may be added simultaneously with the addition of the alcohol of formula (4) after the reaction between the alcohol of formula (1) and the anhydrous magnesium carrier has completed. However, the former is preferred.

The amount of the halogenated hydrocarbon of formula (3) in molar ratio may be 0.1-500:1, for example, 0.2-200:1, with respect to the titanium compound of formula (2).

The reaction temperature in (c) may be in a range of 20-120° C.

When adding the halogenated hydrocarbon after (b), the reaction product in (b) is sufficiently washed using a non-polar solvent to remove reaction byproducts and the unreacted titanium compound before the halogenrated hydrocarbon is added.

The catalyst prepared using the above-described method can be used as it is or after being processed into a solid supported-catalyst by removing the solvent therefrom to polymerize olefin. In the later case, the solid supported-catalyst is dissolved in a non-polar solvent to form a slurry and then added.

Solvents used in the above-described method of preparing the catalyst are non-polar solvent. However, polar solvents can be used as long as they do not accompany a chemical reaction with the compounds and reaction products involved in the synthesis process of the catalyst.

Compounds used in the above-described method of preparing the catalyst should be liquid or at least partially soluble in a non-polar solvent at least at a temperature for the reaction involved in the method. Examples of the non-polar solvent include isobutane, pentane, hexane, n-heptane, octane, nonane, decane, isomers of the forgoing solvents, an alicyclic compound such as cyclohexane, an aromatic compound such as benzene, toluene, ethylbenzene, etc. Hexane is a most commonly used non-polar solvent. Non-polar solvents have to be purified by an appropriate method before being used to remove materials, such as water, oxygen, polar compounds, etc., which affect the activity of the catalyst. The catalyst prepared according to the above-describe method is used together with a cocatalyst of formula (5) below to polymerize olefin.
(R⁵)yMX′(_{3-y}) (5)

where each R⁵ is the same or different and is an alkyl group having 1-10 carbon atoms; M is an element selected from the group consisting of group IB elements, group IIA elements, group IIIB elements, and group IVB elements in the Periodic Table of Elements; X′ is a halogen; and y is an integer from 1 to 3.

When M in formula (5) is aluminum, R⁵ is an alkyl group having 1-5 carbon atoms, and preferably, 2-4 carbon atoms. The halogen for M may be Cl or Br, wherein Cl is preferred.

Examples of compounds containing aluminum for M in formula (5) include triethylaluminum, methylaluminum dichloride, methylaluminum dibromide, dimethylaluminum chloride, dimethylaluminum bromide, propylaluminum dichloride, propylaluminum dibromide, butylaluminum dichloride, butylaluminum dibromide, dibutylaluminum chloride, dibutylaluminum bromide, isobutylaluminum dichloride, isobutylaluminum dibromide, diisobutylaluminum chloride, diisobutylaluminum bromide, hexylaluminum dichloride, hexylaluminum dibromide, dihexylaluminum chloride, dihexylaluminum chloride, octylaluminum dichloride, octylaluminum dibromide, dioctylaluminum chloride, dioctylaluminum bromide, etc.

The cocatalyst of formula (5) greatly affects the polymerization activity of a magnesium-supported catalyst. When M in formula (5) is aluminum, the molar ratio of the aluminum to titanium in the catalyst may be at least 3:1, for example, 10:1, 25:1, 100:1, or 200:1.

The cocatalyst and the catalyst may be added into a polymerization reactor separately or after being mixed together.

A polymerization process using the high-activity magnesium-supported catalyst according to the present invention may be a liquid phase process, a slurry or vapor-phase process, a combination of slurry and vapor-phase processes, etc. However, the slurry or vapor-phase process is preferred.

The high-activity magnesium-supported catalyst according to the present invention can be used after being diluted as a slurry, which is obtained by dissolving the catalyst in a solvent, for example, an aliphatic hydrocarbon solvent including 5-12 carbon atoms, which is suitable for olefin polymerization, such as pentane, hexane, heptane, nonane, decane, or isomers of these solvents, an aromatic hydrocarbon solvent such as toluene, benzene, etc., a hydrocarbon solvent with chlorine substituent, such as dichloromethane, chlorobenzene, etc.

Olefin monomers which can be polymerized using the high-activity magnesium-supported catalyst according to the present invention include ethylene, propylene, a -olefin, cyclic olefin, etc. Dien or triene olefin monomers with at least two double bonds can be polymerized using the catalyst according to the present invention. Examples of such monomers include ethylene, propylene, 1-butene, 1-pentene, 4-methyl-1-pentene, 1-hexene, 1-heptene, 1-decene, 1-undecene, 1-dodecene, 1-tetradecene, 1-hexadecene, 1-icosene, norbonene, norbonadiene, ethylidene norbonene, vinyl norbonene, dicyclopentadiene, 1,4-butadiene, 1,5-pentadiene, 1,6-hexadiene, styrene, α-methylstyrene, divinylbenzene, 3-chloromethylstyrene, etc. At least two kinds of these monomers may be copolymerized.

When polymerizing the above-listed monomers using the high-activity magnesium-supported catalyst according to the present invention, the polymerization temperature may be in a range of 25-500° C., preferably, 25-200° C., and more preferably, 50-150° C. The polymerization pressure may be in a range of 1-100 Kgf/cm², preferably, 1-70 Kgf/cm², and more preferably, 5-50 Kgf/cm². The molecular weight of a final polymer can be controlled using hydrogen, which is the most commonly used method. The molecular weight of a final polymer can be confirmed by measuring the melt index (l₂) of the polymer.

A polyolefin obtained through the polymerization process has a wide range of molecular weights and can be used for various molded products, such as rotary-molded products, injection-molded products, films, containers, pipes, fibers, etc.

Hereinafter, the preset invention will be described in greater detail with reference to the following examples. The following examples are for illustrative purposes and are not intended to limit the scope of the present invention.

### EXAMPLES

Organic reagents and solvents used to synthesize catalysts and polymers were purchased from Aldrich Co., and purified according to standard methods. Hydrogen and ethylene were filtered through a water and oxygen filtering device and used for polymerization. All stages of the catalyst synthesis and polymerization were performed without exposure to air and moisture.

The apparent (bulk) density of each polymer was measured according to DIN 53466 and ISO R 60 using an apparent density tester 1132 (APT Institute fr Prftechnik).

The melt index (Ml) of each polymer was measured according to ASTM D-1238 (conditions E and F, 190° C.). The melt index measured at condition E was denoted as l_{2,} and the melt index measured at condition F was denoted as l₂₁.

The particle size of each polymer was measured using a particle size analyzer (Marlvern Co.), and the span of the distribution is defined as:

$$Span = \frac{ⅆ ( x , 0.9 ) - ⅆ ( x , 0.1 )}{ⅆ ( x , 0.5 )}$$

The x is replaced by any of the letters v, s, l, n that define the distribution type. The span gives a description of the width of the distribution which is independent of the median size.

The amount of the titanium compound in each catalyst was calculated by measuring the absorbance of titanium atom using a UV device.

### Example 1

<Synthesis of Catalyst >

34 g of anhydrous magnesium chloride (99% or greater by weight, containing less than 1% of moisture) and 600 mL of purified hexane containing less than 0.5 ppm of water were put into a 2L- Buchi reactor dried with nitrogen. 175 mL of anhydrous 2-ethyl-1-hexanol was added into the reactor while stirring the reactants. The mixture was stirred at 130° C. for about 2 hours to obtain a solution of the magnesium compound homogenized in the alcohol. 200 mL of TiCl₄ was slowly added over 1 hour while stirring the solution at 200 rpm and 35° C., and the stirring continued further for 1 hour to obtain a solid material. The solid material was precipitated, and the liquid phase was removed. The solid precipitate was washed several times with hexane until the concentration of titanium in the solution reached 0.5 mmol or less. Next, purified hexane was added up to a total volume of 1 L. The concentration of titanium in the slurry was 20-40 mM. 7 mL of cyclohexylchloride was added to the slurry at 40° C. and stirred for 1 hour to obtain a final catalyst.

<Synthesis of Polyethylene by Batch Polymerization >

1 l of purified hexane was put into a 2 l-stainless steel autoclave polymerization reactor, which had been sufficiently filled with nitrogen and vacuum-dried for 3 hours, and heated to 80° C. 4 mmol of triethyl aluminum was added as a cocatalyst into the reactor, and 0.02 mmol of the catalyst synthesized above was added. Hydrogen was supplied into the reactor until the pressure of the reactor reached 3.5 Kgf/cm² while agitating the reactor at 800 rpm. Next, ethylene was continuously added into the reactor for 2 hours while maintaining the pressure of the reactor at 9 Kgf/cm². An ethylene supply valve was closed, the agitator was stopped, and the unreacted gas was discharged, thereby terminating polymerization.

The polymerization product was filtered to remove the solvent and dried in a vacuum oven at 80° C. for 4 hours. The results of the polymerization are shown in Table 1.

### Example 2

A catalyst was synthesized in the same manner as in Example 1, except that, after the solution of the magnesium compound homogenized in the alcohol was cooled down to room temperature, 20 mL of butanol and 20 mL of ethanol were dropwise added while stirring the solution, and left overnight at room temperature while stirring to allow full reaction. Ethylene was polymerized in the same manner as in Example 1. The results of the polymerization are shown in Table 1.

### Example 3

A catalyst was synthesized in the same manner as in Example 1, except that, after the reaction product from the reaction with TiCl₄ was precipitated to obtain a solid material, and the liquid phase of the reaction product was removed, the remaining solid material was washed twice with 1 L of hexane, and 100 mL of a TiCl₄ solution was slowly added over 30 minutes at 80° C. and stirred further for 1 hour. Ethylene was polymerized in the same manner as in Example 1. The results of the polymerization are shown in Table 1.

### Example 4

A catalyst was synthesized in the same manner as in Example 1, except that 16.6 mL of cyclohexylchloride was added. Ethylene was polymerized in the same manner as in Example 1. The results of the polymerization are shown in Table 1.

### Example 5

A catalyst was synthesized in the same manner as in Example 1, except that 33 mL of cyclohexylchloride was added. Ethylene was polymerized in the same manner as in Example 1. The results of the polymerization are shown in Table 1.

### Example 6

A catalyst was synthesized in the same manner as in Example 1, except that 50 mL of cyclohexylchloride was added. Ethylene was polymerized in the same manner as in Example 1. The results of the polymerization are shown in Table 1.

### Example 7

A catalyst was synthesized in the same manner as in Example 1, except that 15.8 mL of benzylchloride instead of cyclohexylchloride was added. Ethylene was polymerized in the same manner as in Example 1. The results of the polymerization are shown in Table 1.

### Example 8

A catalyst was synthesized in the same manner as in Example 1, except that 32 mL of benzylchloride instead of cyclohexylchloride was added. Ethylene was polymerized in the same manner as in Example 1. The results of the polymerization are shown in Table 1.

### Comparative Example 1

A catalyst was synthesized in the same manner as in Example 1, except that cyclohexylchloride was not added. Ethylene was polymerized in the same manner as in Example 1. The results of the polymerization are shown in Table 1.

### Comparative Example 2

A catalyst was synthesized in the same manner as in Example 3, except that cyclohexylchloride was not added. Ethylene was polymerized in the same manner as in Example 1. The results of the polymerization are shown in Table 1.

### Comparative Example 3

A catalyst was synthesized in the same manner as in Example 1, except that 16.6 mL of CCl₄ instead of cyclohexylchloride was added. Ethylene was polymerized in the same manner as in Example 1. The results of the polymerization are shown in Table 1.

TABLE 1

| | Amount of | Bulk density | | MFR (21.6 kg/ | Particle | Span of |
|---|---|---|---|---|---|---|
| Example | polymer (g) | (g/cc) | MI(2.16 kg) | 2.16 kg) | Size (μm) | Distribution |
| Comparative | 90 | 0.340 | 1.4 | 31.0 | 168 | 0.80 |
| Example1 | | | | | | |
| Comparative | 85 | 0.352 | 1.9 | 34.2 | 159 | 0.78 |
| Example2 | | | | | | |
| Comparative | 80 | 0.369 | 2.4 | 35.3 | 140 | 0.87 |
| Example 3 | | | | | | |
| Example 1 | 135 | 0.342 | 1.1 | 45.5 | 173 | 0.83 |
| Example 2 | 123 | 0.350 | 1.6 | 37.6 | 163 | 0.81 |
| Example 3 | 138 | 0.356 | 1.9 | 43.9 | 165 | 0.84 |
| Example 4 | 145 | 0.328 | 2.2 | 39.4 | 175 | 0.83 |
| Example 5 | 156 | 0.325 | 1.5 | 38.5 | 180 | 0.82 |
| Example 6 | 169 | 0.293 | 1.7 | 42.3 | 185 | 0.96 |
| Example 7 | 132 | 0.326 | 1.3 | 46.3 | 170 | 0.89 |
| Example 8 | 140 | 0.332 | 2.0 | 37.5 | 182 | 0.85 |

As is apparent from the results in Table 1, the activities of the catalysts according to the present invention used to synthesize polyethylenes are high. This is due to the addition of cyclohexylchloride or benzylchloride, which change the electrical properties of titanium by coordinating around titanium atoms which are active sites of the catalyst. In addition, large substituents of cyclohexylchloride or benzylchloride provide considerable steric space between the titanium atoms, thereby improving the activity of the catalyst.

### Example 9

34 g of anhydrous magnesium chloride (99% or greater by weight, containing less than 1% of moisture) and 600 mL of purified hexane containing less than 0.5 ppm of water were put into a 2L- Buchi reactor dried with nitrogen. 175 mL of anhydrous 2-ethyl-1-hexanol and 25 mL of cyclohexylchloride were added into the reactor while stirring the reactants. The mixture was stirred at 130° C. for about 2 hours to obtain a solution of the magnesium compound homogenized in the alcohol. 200 mL of TiCl₄ was slowly added over 1 hour while stirring the solution at 200 rpm and 35° C., and the stirring continued further for 1 hour to obtain a solid material. The solid material was precipitated, and the liquid phase was removed. The solid precipitate was washed several times with hexane until the concentration of titanium in the solution reached 0.5 mmol or less. Next, purified hexane was added up to a total volume of 1 L, thereby resulting in a final catalyst. The concentration of titanium was 20-40 mM. Ethylene was polymerized in the same manner as in Example 1. The results of the polymerization are shown in Table 2.

### Example 10

A catalyst was synthesized in the same manner as in Example 9, except that 65 mL of cyclohexylchloride was added. Ethylene was polymerized in the same manner as in Example 1. The results of the polymerization are shown in Table 2.

### Example 11

A catalyst was synthesized in the same manner as in Example 9, except that 130 mL of cyclohexylchloride was added. Ethylene was polymerized in the same manner as in Example 1. The results of the polymerization are shown in Table 2.

### Example 12

A catalyst was synthesized in the same manner as in Example 9, except that 200 mL of cyclohexylchloride was added. Ethylene was polymerized in the same manner as in Example 1. The results of the polymerization are shown in Table 2.

TABLE 2

| | Amount of | Bulk density | | MFR (21.6 kg/ | Particle | Span of |
|---|---|---|---|---|---|---|
| Example | polymer (g) | (g/cc) | MI (2.16 kg) | 2.16 kg) | Size (μm) | Distribution |
| Comparative | 90 | 0.340 | 1.4 | 31.0 | 168 | 0.80 |
| Example 1 | | | | | | |
| Example 9 | 145 | 0.350 | 1.6 | 31.5 | 172 | 0.78 |
| Example 10 | 168 | 0.336 | 1.3 | 39.3 | 173 | 0.81 |
| Example 11 | 154 | 0.320 | 2.3 | 42.1 | 164 | 0.85 |
| Example 12 | 135 | 0.298 | 2.5 | 41.9 | 165 | 0.93 |

As is apparent from the results in Table 2, the activities of the catalysts according to the present invention used to synthesize polyethylenes are very high. The activity of a catalyst according to the present invention can be controlled during reaction with the halogenated hydrocarbon or according to the amount of the halogenated hydrocarbon.

As described above, a magnesium-supported catalyst according to the present invention contains a halogenated hydrocarbon component and has highly improved polymerization activity. In addition, the magnesium-supported catalyst according to the present invention still has characteristics of catalysts which do not contain halogenated hydrocarbon and thus can be easily used in conventional commercial processes.

A high-activity magnesium-supported Ziegler-Natta catalyst according to the present invention is suitable to produce polyethylene through a vapor-phase or slurry polymerization process and thus can be used to produce various kinds of polyolefin products, such as molded products, films, containers, pipes, fibers, etc. In addition, the catalyst according to the present invention has a very high activity and can be manufactured at low costs. Furthermore, the catalyst according to the present invention does not cause an off-flavor or off-taste to a resin synthesized using the same, and thus is suitable for containers, especially for foods.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a catalyst for olefin polymerization, the method comprising:
(a) contacting a solid anhydrous magnesium carrier and an alcohol of formula (1) below in a non-polar solvent to react the solid anhydrous magnesium carrier and the alcohol;
(b) contacting the reaction product from (a) and at least one titanium compound of formula (2) below to react the product from (a) and the titanium compound; and
(c) adding a halogenated hydrocarbon of formula (3) below during (a) or after (b) for reaction with the reactants:
R¹ —OH (1)
where R¹ is an alkyl group having 6-10 carbon atoms.
Ti(OR²)lX₄₋ₗ (2)
where each R² is the same or different and is an alkyl group having 1-10 carbon atoms, X is a halogen atom, and l is an integer from 0 to 4
R³X (3)
where R³ is a substituted or unsubstituted aryl group having 6-30 carbon atoms, a substituted or unsubstituted heteroaryl group having 4-30 carbon atoms, a substituted or unsubstituted cycloalkyl group having 5-30 carbon atoms, or a substituted or unsubstituted heterocycloalkyl group having 3-30 carbon atoms; and X is a halogen atom.

2. The method of claim 1, further comprising contacting the reaction product from (a) and at least one alcohol of formula (4) below after the reaction in (a):
R⁴—OH (4)
where R⁴ is an alkyl group having 1-5 carbon atoms.

3. The method of claim 1, further comprising sufficiently washing the reaction product from (b) with a non-polar solvent before (c) when the halogenated hydrocarbon of formula (3) is added after the reaction between the reaction product from (a) and the titanium compound of formula (2) in (b).

4. The method of claim 1, wherein the amount of the alcohol of formula (1) in molar ratio is in a range of 1-10:1 with respect to the amount of the solid anhydrous magnesium carrier.

5. The method of claim 2, wherein the amount of the alcohol of formula (4) in molar ratio is in a range of 0.25-10:1 with respect to the amount of the solid anhydrous magnesium carrier.

6. The method of claim 1, wherein the amount of the halogenated hydrocarbon of formula (3) in molar ratio is in a range of 0.1-500:1 with respect to the total amount of the alcohol.

7. The method of claim 1, wherein the amount of the titanium compound of formula (2) in molar ratio is in a range of 1-20:1 with respect to the amount of the solid anhydrous magnesium carrier.

8. The method of claim 1, wherein the molar ratio of the halogenated hydrocarbon of formula (3) to the titanium compound of formula (2) is in a range of 0.1-500:1.

9. The method of claim 1, wherein the reaction temperature in (a) is in a range of 20-150° C.

10. The method of claim 1, wherein the reaction temperature in (b) is in a range of −20-80° C.

11. The method of claim 1, wherein the reaction temperature in (c) is in a range of 20-120° C.

12. A catalyst prepared using the method of any one of claim 1.

13. A method of preparing polyolefin using the catalyst of claim 12 and a cocatalyst of formula (5) below:
(R⁵)yMX′(_{3-y}) (5)
where each R⁵ is the same or different and is an alkyl group having 1-10 carbon atoms; M is an element selected from the group consisting of group IB elements, group IIA elements, group IIIB elements, and group IVB elements in the Periodic Table of Elements; X′ is a halogen; and y is an integer from 1 to 3.

14. The method of claim 13, being performed in a slurry or vapor-phase process.

15. The method of claim 13, being performed at a temperature of 50-150° C.
